(19) United States
(12) Patent Application Publication
(10) Pub. No.: US 2022/0095739 A1
(43) Pub. Date: Mar. 31, 2022

(54) AN INSOLE FOR A FOOTWEAR

(71) Applicant: VIBRANT TECHNOLOGY PTE. LTD., Singapore (SG)

(72) Inventor: Wade O'Brien BRACKENBURY, Fairfield, ID (US)

(21) Appl. No.: 17/426,536

(22) PCT Filed: Nov. 4, 2019
(86) PCT No.: PCT/IB2019/059424

§ 371 Date: Jul. 28, 2021

(30) Foreign Application Priority Data
Jan. 29, 2019 (VN) 1-2019-00547

(51) Int. Cl. A43B 7/142; A43B 17/00; A43B 7/02; A43B 13/40

(52) U.S. Cl. CPC A43B 7/142; A43B 13/40; A43B 7/02; A43B 17/006

(57) ABSTRACT

The invention relates to an insole for a footwear including a non-moldable base layer (310) having an arch supporting portion (312) adapted to support an arch of a foot; and a moldable layer (330) overlaying the non-moldable base layer (310), such that the moldable layer (330) is adapted to be molded to conform to the arch of the foot. The invention also relates to a footwear comprising the insole.

### TECHNICAL FIELD

The present invention relates to an insole for a footwear. For example, an insole for correcting foot pronation, a biomedical foot support, a foot orthotic, etc.

BACKGROUND

Insoles or foot orthotics are used to correct pronated (over pronation) or supinated (under pronation) feet. When a person has pronated feet, the stresses to the body due to the pronation can lead to injuries in the long term. Such insoles are inserted between the feet and footwear to support the arch during walking or running to correct the pronation. The insoles may be used to correct flat foot, diabetic foot and other foot disorders. Furthermore, the insoles may be used for runners, bikers, and other athletes. Footwear may include shoes, slippers, sandals, etc.

Existing insoles are moldable to assume the shape of the sole of the foot for comfort and precise fit. However, such insoles may be flattened and therefore distorted during the molding of the insoles. For example, when excess pressure is applied to the insoles during the molding process, the insole may be flattened. When the insoles are distorted, the insoles would not be able to fulfil the purpose of correcting the pronation, thus reducing the effectiveness of the insole.

In addition, a certain level of expertise is required to customise the insoles to fit the feet. Therefore, the costs for such insoles can be relatively expensive and fabricating the insoles can be time consuming and require repeated trips to a qualified practitioner.

There are also insoles that can be molded when heated. For example, the insoles can be soaked in boiling water to soften them. While the boiling water method may be the effective for even heat distribution around the insoles, the method does not provide a consistent temperature distribution throughout the insoles. There is also the issue of the temperature of the insoles dropping rapidly once the insoles are removed from the boiling water, even before the molding can happen. In some instances, there are also insoles that can be heated in convection ovens and by heat guns. However, such methods often lead to over-heating and denaturing of the material or underheating resulting in inadequate molding and correction. Furthermore, when heat is applied to the exterior of the insoles, the temperature of the heat applied has to be much higher than needed in order for the heat to be transmitted deeply enough into the material for molding to be possible. In this way, energy is wasted due to the high energy required. In addition, there may be uneven heating of the material as the outer portion of the insoles would be hotter than the inner portion of the insoles.

### SUMMARY

According to various embodiments, an insole for a footwear is provided. The insole includes a non-moldable base layer having an arch supporting portion adapted to support an arch of a foot; and a moldable layer overlaying the non-moldable base layer, such that the moldable layer is adapted to be molded to conform to the arch of the foot.

According to various embodiments, the moldable layer may be configured to transform between a deformable state to be molded to conform to the arch of the foot and a non-deformable state to cease the molding.

According to various embodiments, the non-moldable base layer may include a heel portion at one end of the non-moldable base layer, a toe portion at another end opposite the one end, such that the arch supporting portion may be disposed between the heel portion and the toe portion, and such that the moldable layer overlays the heel portion and the arch supporting portion.

According to various embodiments, the insole may further include a heating layer adapted to heat the moldable layer.

According to various embodiments, the heating layer may be attached to the moldable layer and disposed between the moldable layer and the non-moldable base layer.

According to various embodiments, the heating layer may include a heating element.

According to various embodiments, the insole may further include at least one of a first cavity and a second cavity between the non-moldable base layer and the moldable layer, such that the first cavity and the second cavity are adapted to receive the moldable layer therein.

According to various embodiments, the arch supporting portion may include a rearward side facing the heel portion and a forward side facing the toe portion, such that the first cavity may be disposed along the heel portion and the rearward side of the arch supporting portion and the second cavity may be disposed along the forward side of the arch supporting portion.

According to various embodiments, the moldable layer may include an adhesive side facing the non-moldable base layer, such that the moldable layer may be adapted to adhere to the non-moldable base layer when the moldable layer is being molded into the at least one of the first cavity and the second cavity.

According to various embodiments, the moldable layer may have a uniformed thickness throughout its length.

According to various embodiments, a footwear having an insole as described in any one of the above embodiments is provided.

### BRIEF DESCRIPTION OF DRAWINGS

FIG. 1 shows a sectional view of an exemplary embodiment of an insole for a footwear.

FIG. 2 shows a sectional view of an example of the insole in a molded profile.

FIG. 3 shows a sectional view an exemplary embodiment of the insole having a heating layer adapted to heat the moldable layer.

FIG. 4 shows a sectional view of another exemplary embodiment of the insole.

FIG. 5 shows a top view of the moldable layer in FIG. 4 on the non-moldable base layer.

FIG. 6 shows another top view of the moldable layer in FIG. 4 on the non-moldable base layer.

FIG. 7 shows a top view of an exemplary embodiment of the heating layer having the heating element.

FIG. 8 shows a top view of an exemplary embodiment of the heating layer.

### DETAILED DESCRIPTION

FIG. 1 shows a sectional view of an exemplary embodiment of an insole 100 for a footwear. Insole 100 has a non-moldable base layer 110 with an arch supporting portion 112 adapted to support an arch of a foot (not shown in FIG. 1) and a moldable layer 130 overlaying the non-moldable base layer 110, such that the moldable layer 130 is adapted to be molded to conform to the arch of the foot. Insole 100 may include a covering layer 150 overlaying the moldable layer 130.

As shown in FIG. 1, the non-moldable base layer 110 has a heel portion 114 at one end 110A of the non-moldable base layer 110, a toe portion 116 at another end 110B opposite the one end 110A. Arch supporting portion 112 may be disposed between the heel portion 114 and the toe portion 116. Heel portion 114 may be the portion of the non-moldable base layer 110 that supports the heel of the foot. Toe portion 116 may be the portion of the non-moldable base layer 110 that supports the toes of the foot. Arch supporting portion 112 may be the portion of the non-moldable base layer 110 that supports the arch of the foot. Arch supporting portion 112 may extend from the heel portion 114 to and/or before the toe portion 116. Arch supporting portion 112 may extend to support the ball of the foot. As shown in FIG. 1, the arch supporting portion 112 may be higher than the heel portion 114 and toe portion 116. Moldable layer 130 may include a proximal portion 130P at its first end 130F, a distal portion 130D at its second end 130S opposite the first end 130F and a centre portion 130C between the proximal portion and the distal portion 130D. Moldable layer 130 may overlay the non-moldable base layer 110 by covering the non-moldable base layer 110 throughout its length. Moldable layer 130 may extend from the one end 110A to the another end 110B of the non-moldable base layer 110, i.e. the moldable layer 130 may overlay the heel portion 114, the arch supporting portion 112 and the toe portion 116. Moldable layer 130 may overlay a portion of the non-moldable base layer 110. For example, as shown in FIG. 1, the moldable layer 130 may overlay the heel portion 114 and the arch supporting portion 112. Moldable layer 130 may extend from one end 110A of the insole 100 to and before the toe portion 116 of the non-moldable base layer 110 which may be about two-thirds the length of the non-moldable base layer 110. Moldable layer 130 may be formed to conform to the top profile of the non-moldable base layer 110. Moldable layer 130 may span across the width of the non-moldable base layer 110. Moldable layer 130 may span the width and length of the heel portion 114 and arch supporting portion 112 of the non-moldable base layer 110. Non-moldable base layer 110 may be a support layer adapted to support the moldable layer 130.

Non-moldable base layer 110 may be non-moldable or resilient to deformation so that the under the weight of the user over time, the non-moldable base layer 110 may not deform. Non-moldable base layer 110 may be made from non-moldable or non-deformable material, e.g. ethylene-vinyl acetate (EVA), polyurethane (PU) foam, blown EVA, polylactic acid (PLA), and other suitable thermoplastic, etc. Hence, the insole 100 may be able to provide proper and adequate support for foot without losing its shape. Moldable layer 130 may be configured to transform between a deformable state to he molded to conform to the arch of the foot and a non-deformable state to cease the molding. Moldable layer 130 may be made from a material that is moldable so that it may be molded to conform to the profile of sole or arch of the foot, i.e. a foot profile, so as to fit the insole 100 to the foot profile properly and comfortably. Moldable layer 130 may be injection or compression molded. Moldable layer 130 may composed of material like ethylene-vinyl acetate (EVA), ethylene-ethyl acrylate (EEA), non-blown EVA, polylactic acid (PLA), a solid, e.g. non-blown material which is not a foam, and other suitable thermoplastic, etc. Once the molding process is completed, the moldable layer 130 may be transformed to the non-moldable or non-deformable state such that the molding may ceased. In this way, the moldable layer 130 can take the shape of the foot profile and remain in the molded shape.

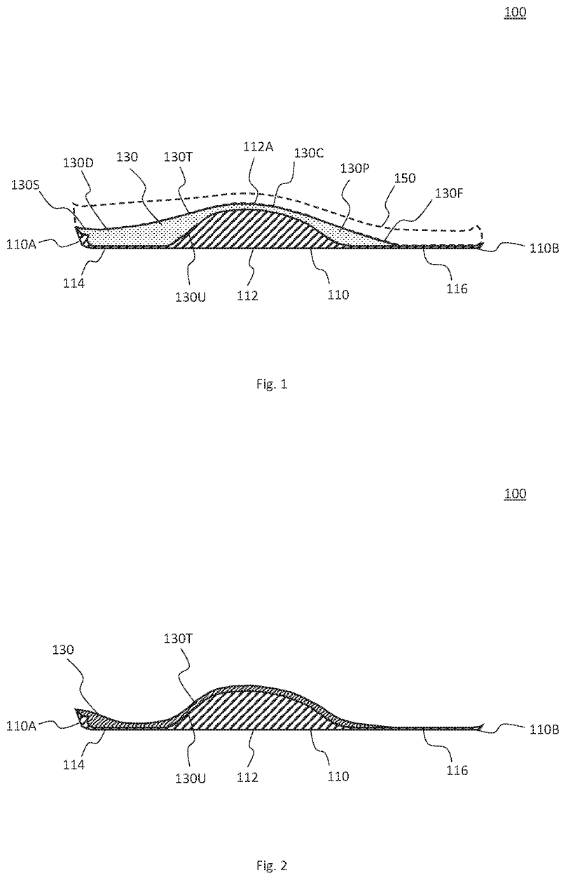

FIG. 1 shows an example of the insole 100 in an initial profile. Initial profile may be the profile before the insole 100 is being molded. Initial profile may be the least corrected profile, or a profile of a least molded profile where the foot profile requires minimal or no correction. FIG. 2 shows a sectional view of an example of the insole 100 in a molded profile. Molded profile may be the profile of the moldable layer 130 when molding has ceased. As shown in FIG. 2, the moldable layer 130 may be molded to substantially the top profile of the non-moldable base layer 110. Non-moldable base layer 110 may have a most corrected profile or a profile for the foot that requires maximum correction. It can be appreciated that the moldable layer 130 may be molded to any intermediate profile between the least corrected profile and the most corrected profile.

Insole 100 may allow the optimal correction of the pronation condition. Moldable layer 100, when moldable, may be deformed with the applied pressure by the foot, e.g. when a person stands on the insole 100. Moldable layer 130 may mold and wrap onto the arch supporting portion 112 as the foot descends and may conform more towards the non-moldable base layer 110 with more applied pressure. When the foot reaches its optimal possible correction, e.g. 100% of its possible correction position, the moldable layer 130 may not be molded further if the foot is kept in talar neutral position. In this way, the moldable layer 130 is able to be fit to the foot properly and correction to the foot is optimised. By enabling an optimal correction, the insole 100 mitigates risks of under or over correcting. Non-moldable base layer 110, as shown in FIG. 1, may be in an extreme correction profile, i.e. the apex 112A of the arch supporting portion 112 is highest from its base where the heel portion 114 and the toe portion 116 are connected thereto. In other words, the extreme molded profile may be formed where the height difference between the centre portion 130C and the proximal portion 130P and/or distal portion 130D of the moldable layer 130 is at its maximum. In a condition of where “extreme” or most correction is required, e.g. flat-footed users, the moldable layer 130 may be pressed to substantially the profile of the non-moldable base layer 110. In this profile, the moldable layer 130 corresponds with the profile of the non-moldable base layer 110. Once molded, the moldable layer 130 may not expand thereafter. It can be appreciated that the moldable layer 130 can be molded to suit a variety of foot profiles, e.g. over or under pronation. In this way, the insole 100 may easily be customised to suit a wide range of pronation conditions, e.g. over-pronation to under-pronation, and be able to biomedically correct the pronation of the foot. Furthermore, the insole 100 may be suitable for varying flat foot conditions, from a rigid flat foot that requires slight arch support to a flexible flat foot that requires high arch support.

Referring to FIG. 1, the moldable layer 130 may include a top side 130T that contacts the foot and an underside 130U opposite the top side 130T where the underside 130U may be in contact with and supported by the non-moldable base layer 110. To conform the moldable layer 130 to the foot profile, in a moldable state, the moldable layer 130 may be molded under the weight of the foot where the top side 130T may conform to the foot profile. At the same time the top side 130T may be pressed towards the non-moldable base layer 110. When the foot is in the correcting position, i.e. a position to correct the pronation or talar neutral position, the molding process may be ceased to prevent further changes to the top side 130T. At this stage, once the molding process has stopped, the moldable layer 130 remains in the molded profile and the top side 130T remains in the correcting profile or molded profile. Moldable layer 230 may be a moldable foam, e.g. memory foam, that may be molded to the foot profile without the heating layer 260.

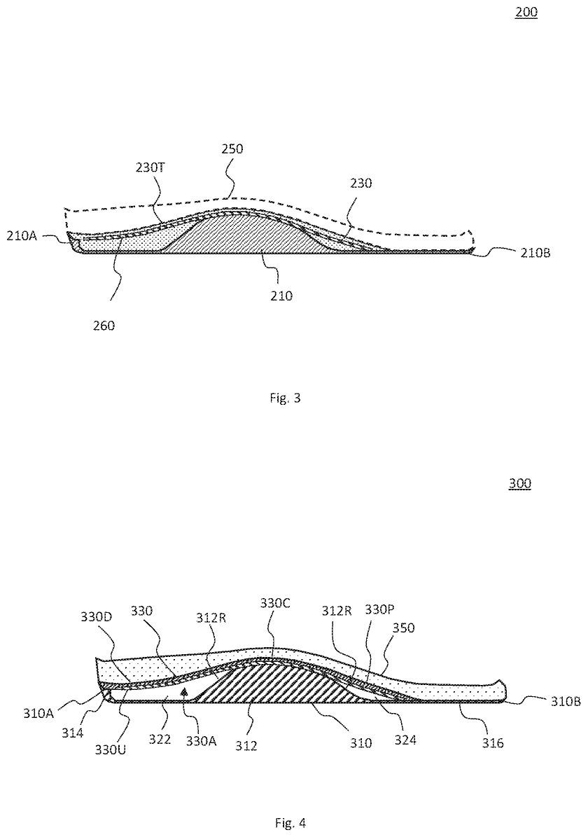

FIG. 3 shows a sectional view an exemplary embodiment of the insole 200 having a heating layer 260 adapted to heat the moldable layer 230. Heating layer 260 may be embedded within the moldable layer 230. Heating layer 260 may be consistently spaced from the top side 230T of the moldable layer 230 along the length of the moldable layer 230. Heating layer 260 may be spaced at an interval from the top side 230T such that the heat from the heating layer 260 would not burn the foot during the molding process. Insole 200 may include the covering layer 250 as shown in FIG. 1 to provide further thermal insulation. As mentioned, the moldable layer 230 may be transformed from a deformable state to a non-deformable state. Moldable layer 230 may be heated to the deformable state so that the moldable layer 230 may conform to the foot profile and cooled to the non-deformable state to prevent further deformation so as to support the arch of the foot. Insole 100 may include one or more vents (not shown in FIG. 3) for excess material of the moldable layer 130 to be released during the molding.

FIG. 4 shows a sectional view of another exemplary embodiment of the insole 300. Similar to the earlier embodiment, the insole 300 has the non-moldable base layer 310 with the arch supporting portion 312 adapted to support an arch of a foot (not shown in FIG. 4) and the moldable layer 330 overlaying the non-moldable base layer 310, such that the moldable layer 330 is adapted to be molded to conform to the arch of the foot. Insole 300 may include the covering layer 350 overlaying the moldable layer 330.

Insole 300 may include at least one of a first cavity 322 and a second cavity 324 between the non-moldable base layer 310 and the moldable layer 330. First cavity 322 and the second cavity 324 may be adapted to receive the moldable layer 330 therein. First cavity 322 may be disposed under the proximal portion 330P of the moldable layer 330. Second cavity 324 may be disposed under the distal portion 330D of the moldable layer 330. As shown in FIG. 4, the moldable layer 330 may have a uniformed thickness throughout its length, e.g. 10 mm-15 mm, preferably 11 mm-14 mm, preferably 12 mm. Thickness of the moldable layer 330 may vary according to the weight of the user. First cavity 322 and the second cavity 324 of the moldable layer 330 may allow displacement of the relevant portions of the moldable layer 330 thereinto. When the moldable layer 330 is in the deformable state, as the foot is pressed down onto the insole 300, the distal portion 330D may be pressed or displaced into the second cavity 324 and the proximal portion 330P may be pressed or displaced into the first cavity 322. Centre portion 330C of the moldable layer 330, being supported by the arch supporting portion 312, is not displaced downwards. When the molding is ceased and the moldable layer 330 may be in the non-deformable state, the moldable layer 330 may conform to foot profile. Insole 300 may include one or more vents (not shown in FIG. 4) to allow air within the first cavity 322 and the second cavity 324 to be released when the moldable layer 330 is pressed into them. In an extreme correction profile, the first cavity 322 and/or the second cavity 324 may disappear as the underside 330U of the moldable layer 330, and/or the bottom side 360B of the heating layer 360, contacts the non-moldable base layer 310. Insole 300 may include a single cavity connecting the first cavity 322 and the second cavity 324. Insole 300 may include a plurality of cavities, e.g. 3 cavities, 4 cavities. Compared to the moldable layer 330 in FIG. 1, the moldable layer 330 in FIG. 4, being thinner requires less heat energy and time to transform it to the deformable state. First cavity 322 and the second cavity 324 may be disposed within the non-moldable base layer 310. Arch supporting portion 312 may include a rearward side 312R facing the heel portion 314 and a forward side 312F facing the toe portion, such that the first cavity 322 may be disposed along the heel portion 314 and the rearward side 312R of the arch supporting portion 312 and the second cavity 324 may be disposed along the forward side 312F of the arch supporting portion 312. Moldable layer 330 may be stretchable to accommodate the depression of the moldable layer 330 into the first cavity 322 and/or second cavity 324.

Referring to FIG. 4, the moldable layer 330 may include an adhesive side 330A facing the non-moldable base layer 310, such that the moldable layer 330 is adapted to adhere to the non-moldable base layer 310 when the moldable layer 330 is being molded into the at least one of the first cavity 322 and the second cavity 324. Underside 330U of the moldable layer 330 may be the adhesive side 330A such that when the moldable layer 330 is wrapped onto the arch supporting portion 312 when it is pressed against the non-moldable base layer 310 during the deformable stage, the underside 330U may be adhered to the non-moldable base layer 310 at the arch supporting portion 312. Non-moldable base layer 310 may be coated with a precursor to adhesion to better adhere the moldable layer 330 to the non-moldable base layer 310 during the molding of the moldable layer 330.

Insole 300 may include a heating layer 360 adapted to heat the moldable layer 330. Heating layer 360 may be disposed adjacent the moldable layer 330, e.g. beneath the moldable layer 330. Heating layer 360 may be disposed within the moldable layer 330. Heating layer 360 may extend along the length of the moldable layer 330. As the heating layer 360 is under the moldable layer 330, less heat can reach the top side of the moldable layer 330, thus lessening the risks of burns during molding. Once molded, the moldable layer 330, due to the thinness thereof, may not revert to the initial profile after molding. In the embodiment where the heating layer 360 is attached to the underside 330U of the moldable layer 330, the bottom side 360B of the heating layer 360, i.e. the side facing away from the moldable layer 330, may be part of the adhesive side 330A so that the moldable layer 330 may wrap onto and adhere to the arch supporting portion 312 of the non-moldable base layer 310. As such, the heating layer 360 may be displaced into the first cavity 322 and/or the second cavity 324. Heating layer 360 may be made from an adhesive material. For example, the heating layer 360 may compose of a derivative of EVA, e.g. a sticky EVA, which allows the heating layer 360 to adhere to the moldable layer 330 and the non-moldable base layer 310 thus bonding them together.

Covering layer 150,250,350 as shown in any one of the embodiments may extend from the one end 210A to the another end 210B of the non-moldable base layer and may span the width of the non-moldable base layer. Covering layer 250 may be made from a compression molded EVA foam, blown EVA or similar material. Covering layer 250 may be flexible to conform to the molded profile of the moldable layer 230. Covering layer 250 may be adapted to provide an additional thermal barrier to the foot while molding and may add comfort, durability and aesthetics to the insole 200.

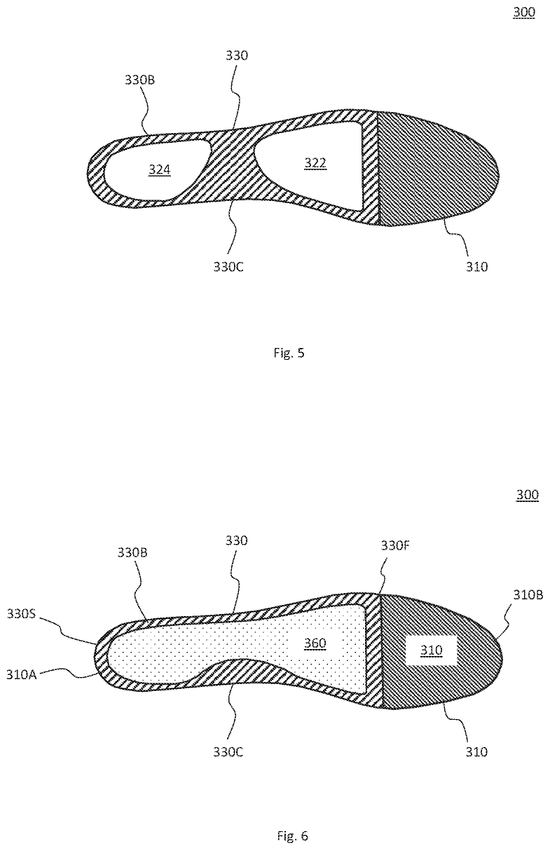

FIG. 5 shows a top view of the moldable layer 330 in FIG. 4 on the non-moldable base layer 310. For clarity, the portion of the moldable layer 330 above the first cavity 322 and the second cavity 324 have been omitted to expose the cavities. Moldable layer 330 may be bonded to the non-moldable base layer 310 along the perimeter edge of the moldable layer 330 and the non-moldable base layer 310 forming a bonded border 330B around the perimeter of the moldable layer 330. In addition, the moldable layer 330 may be bonded to the non-moldable base layer 310 at any area where the moldable layer 330 may not deform or has minimal deformation during the deformable stage, e.g. at the apex (not shown in FIG. 5) of the arch supporting portion 312 of the non-moldable base layer 310 and the centre portion 330C of the moldable layer 330. The portions of the moldable layer 330 that are not bonded to the non-moldable base layer 310 form the first cavity 322 and/or the second cavity 324. Moldable layer 330 may have the same area as the heel portion 314 (not shown in FIG. 5) and the arch supporting portion 312 (not shown in FIG. 5) of the non-moldable base layer 310. Alternatively, the moldable layer 330 may have the same area profile as the non-moldable base layer 310. If the material for the non-moldable base layer 310 and the moldable layer 330 are made from EVA, the bond between the non-moldable base layer 310 and the moldable layer 330 may be much stronger than if the materials were to be glued together. Non-moldable base layer 310 may be bonded to the moldable layer 330 using suitable glue or other glue activation methods commonly used to bond EVA.

FIG. 6 shows another top view of the moldable layer 330 in FIG. 4 on the non-moldable base layer 310. A portion of the moldable layer 330 above the heating layer 360 has been removed to expose the heating layer 360 under the moldable layer 330. Heating layer 360 may be attached to the moldable layer 330 and disposed between the moldable layer 330 and the non-moldable base layer 310. Heating layer 360 may be disposed within the moldable layer 330. Without having the heating layer 360 embedded within the moldable layer 330, i.e. by having the heating layer 360 outside the moldable layer 330, the structure of the moldable layer 330 would not be weakened and thus be able to withstand the molding process better.

As shown in FIG. 6, the heating layer 360 may extend from the first end 330F of the moldable layer 330 to the second end 330S opposite the first end 330F. Heating layer 360 may span the width of the moldable layer 330. Heating layer 360 may be disposed at the heel portion (not shown in FIG. 6) and arch supporting portion (not shown in FIG. 6) of the non-moldable base layer 310. Heating layer 360 may extend to the toe portion 316 of the non-moldable base layer 310. Heating layer 360 may cover the area within the border 330B to provide a well distributed heat source throughout the moldable layer 330 so that the moldable layer 330 may be molded evenly. Heating layer 360 may be activated to heat the moldable layer 330 to cause the moldable layer 330 to be moldable. Heating layer 360 may be de-activated to cause the moldable layer 330 to cease to be moldable or hardened. Moldable layer 330 may be heated to a temperature which is between a temperature which would burn the skin and a temperature which would result the non-moldable base layer 310 to be molten and yet allows the moldable layer 330 to safely mold easily under the body weight of the user. Heating layer 360 may be adhered to the moldable layer 330 using glue, e.g. EVA glue, or by direct adhesion during compression molding of the heating layer 360.

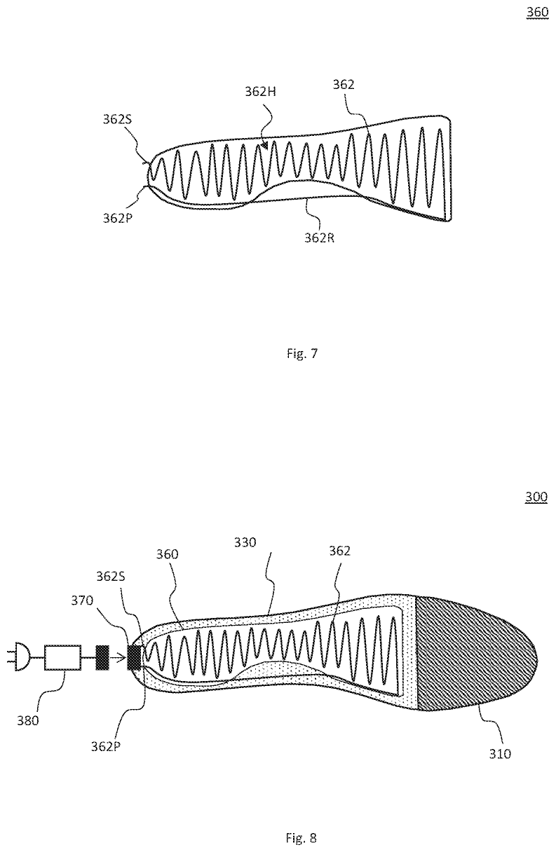

FIG. 7 shows a top view of an exemplary embodiment of the heating layer 360 having the heating element 362. Heating layer 360 may include a heating element 362 i.e. heated electrically. Heating element 362 may be heated chemically, i.e. heating element 362 may be a chemical heating element. Heating layer 360 may be connected to an electrical source (not shown in FIG. 7). Electrical source may be turned on to activate the heating layer 360. Heating element 362 may extend along the length of the heating layer 360. Heating element 362 may span the width of the heating layer 360. As shown in FIG. 7, the heating element 362 may include a resistance wire. Heating element 362 may weave back and forth longitudinally along the width of the heating layer 360. Referring to FIG. 7, the heating element 362 may weave back and forth laterally along the length of the heating layer 360. The latter configuration of the heating element 362, i.e. laterally weaving as shown in FIG. 7, allows the insole 300 to be flexible and provide comfort to the user during walking. Heating layer 360 may be adapted to heat the area of the moldable layer 330 around the arch supporting portion (not shown in FIG. 7) of the non-moldable base layer 310. Heating element 362 may be embedded in the heating layer 360. As shown in FIG. 7, the heating element 362 may be adapted to heat the entire heating layer 360, i.e. the centre and edges of the heating layer 360 evenly. Heating element 362 may include a heating portion 362H and a return portion 362R to return the heating element 362 to the one end 310A of the insole 300. Return portion 362R may include a sheath (not shown in FIG. 7) adapted to encase it so as to prevent the return portion 362R from heating of portions of insole 300 that do not need to be heated. Sheath may include an epoxy sheath, heat resistant wire cover, etc. Heating element 362 may include an input portion 362S where the heating element 362 enters the heating layer 360 and an output portion 362P where the heating element 362 exits the heating layer 360 or vice versa. Input portion 362S and the output portion 362P may exit the insole 300 via the non-moldable base layer (not shown in FIG. 7). Input portion 362S and the output portion 362P may exit the insole 300 via the one end or the another end (not shown in FIG. 7). Input portion 362S and the output portion 362P may be encased, e.g. by epoxy sheath. Further, the sheath may be useful is preventing shorting of the return portion 362R and the heating portion 362H. Heating element 362 may be the heating layer 360 where the heating element 362 is in direct contact with the moldable layer (not shown in FIG. 7).

As the uniformed thickness and relatively slim moldable layer 330, together with the evenly spaced heating element 362 adjacent thereto, insole 330 provides a more uniform heating throughout the moldable layer 330. Consequently, the moldable layer 330 may be transformed into the deformable stage quickly and using less heat. Also, the moldable layer 330 may be heated at the time the foot is pressed onto the moldable layer 330. As such, the heat is channelled completely to the molding process and no unnecessary heat is loss due to transferring of the insole from a heat source to the user as mentioned for conventional insoles. As less energy is required, a smaller and more compact power source is needed to heat the moldable layer 330. Insole 300 may be known as a self-heating, heat moldable insole 300. Heating element 362 may include other forms, e.g. a heating plate, rods, strips, etc. As the molding process of the insole 300 is relatively fast, the insole 300 is suitable for children who are not able to sit down for long period of time.

FIG. 8 shows a top view of an exemplary embodiment of the heating layer 360. Insole 300 may include a connector 370 connected to the heating layer 360 and disposed at the non-moldable base layer 310 for connecting to a power source (not shown in FIG. 8), e.g. wall power socket, a battery pack. Connector 370 may be connected to the input portion 362S and the output portion 362P of the heating element 362. Insole 300 may be connectable to the power source. Insole 300 may include a transformer 380 may be adapted to provide safe, low voltage electricity to the heating element. Transformer 380 may be attachable to the non-moldable base layer 310 via the connector 370 or disposed within the non-moldable base layer 310. Electricity may be applied to the heating layer 360 for the period of time necessary, e.g. 10 mins, to soften the moldable layer 330 to a temperature of safe malleability. Heating layer 360 may be heated to a temperature range of 120° C.-160° C., preferably 130° C.-160° C., preferably 130° C.-140° C., preferably 130° C. Although the temperature of the heating layer 360 is high enough to burn the user's foot, the heat is insulated from the user's foot by the moldable layer 330 and the covering layer (not shown in FIG. 8). The temperature experienced by the user may be about 40° C. or slightly warmer than the user's body temperature.

Insole may include a controller (not shown in FIG. 8) configured to control the temperature and duration of the molding process. Controller may be connected to the heating layer 360. Controller may be attachable to the insole 300 or incorporated into the insole 300. Insole 300 may include a temperature sensor (not shown in FIG. 8) in communication with the controller. Controller may control the current to the heating element 362. Controller may be configured to control the duration of the heating based on pre-programmed durations stored in the controller. Controller may be configured to cut off the power supply at a pre-determined temperature.

It can be appreciated that the insole is designed to be an accommodative, self-molding foot orthotic. Insole may be suitable for correcting common foot problems, such as diabetic foot, pronation, plater fasciitis, etc. As such, the insoles may be mass produced to cater to the masses and yet can be customised and easily fitted to each user by the user. The user may be able to customise the insole easily without the need of a specialist. Consequently, the costs for obtaining such insoles may be more affordable. Further, due to the features of the abovementioned embodiments, the insole allows a relatively light pressure to be exerted on the insole to mold the insole and obtain an optimal correcting configuration for the user, unlike conventional insoles which require a heavy pressure to mold the insole. Conventional insoles then to distort under the heavy pressure thus does not provide an optimal correcting configuration.

A skilled person would appreciate that the features described in one example may not be restricted to that example and may be combined with any one of the other examples.

In the following examples, reference will be made to the figures, in which identical features are designated with like numerals.

The present invention relates to an insole generally as herein described, with reference to and/or illustrated in the accompanying drawings.

1. (canceled)

2. An insole for footwear, the insole comprising:
a non-moldable base layer (310) comprising an arch supporting portion (312) adapted to support an arch of a foot; and a moldable layer (330) overlaying the non-moldable base layer (310), wherein the moldable layer (330) is adapted to be molded to conform to the arch of the foot;
wherein the moldable layer (330) is configured to transform between a deformable state to be molded to conform to the arch of the foot and a non-deformable state to cease the molding.

3. The insole according to claim 1, wherein the non-moldable base layer (310) comprises a heel portion (114) at one end of the non-moldable base layer (310), a toe portion (116) at another end opposite the one end, wherein the arch supporting portion (312) is disposed between the heel portion (114) and the toe portion (116), and wherein the moldable layer (330) overlays the heel portion (114) and the arch supporting portion (312).

4. The insole according to claim 1, further comprising a heating layer (360) adapted to heat the moldable layer (330).

5. The insole according to claim 4, wherein the heating layer (360) is attached to the moldable layer (330) and disposed between the moldable layer (330) and the non-moldable base layer (310).

6. The insole according to claim 4, wherein the heating layer (360) comprises a heating element (362).

7. The insole according to claim 1, further comprising at least one of a first cavity (322) and a second cavity (324) between the non-moldable base layer (310) and the moldable layer (330), wherein the first cavity (322) and the second cavity (324) are adapted to receive the moldable layer (330) therein.

8. The insole according to claim 7, wherein the arch supporting portion (312) comprises a rearward side (312R) facing the heel portion (114) and a forward side (312F) facing the toe portion (116), wherein the first cavity (322) is disposed along the heel portion (114) and the rearward side (312R) of the arch supporting portion (312) and the second cavity (324) is disposed along the forward side of the arch supporting portion (312).

9. The insole according to claim 7, wherein the moldable layer (330) comprises an adhesive side (330A) facing the non-moldable base layer (310), wherein the moldable layer (330) is adapted to adhere to the non-moldable base layer (310) when the moldable layer (330) is being molded into the at least one of the first cavity (322) and the second cavity (324).

10. The insole according to claim 1, wherein the moldable layer (330) has a uniformed thickness throughout its length.

11. A footwear comprising an insole according to claim 1.
